(19) United States
(12) Patent Application Publication
(10) Pub. No.: US 2020/0342380 A1
(43) Pub. Date: Oct. 29, 2020

(54) METHOD AND APPARATUS FOR PREDICTIVE MANAGEMENT AND DISTRIBUTION OF CHARITABLE GOODS

(71) Applicant: HERE GLOBAL B.V., Eindhoven (NL)

(72) Inventors: Olga SELINA, Barrington, IL (US); Chris DOUGHERTY, Highland Park, IL (US)

(21) Appl. No.: 16/394,579

(22) Filed: Apr. 25, 2019

(51) Int. Cl. G06Q 10/06; G06Q 30/02; G06N 20/00

(52) U.S. Cl. CPC G06Q 10/06315; G06N 20/00; G06Q 30/0205; G06Q 30/0202

(57) ABSTRACT

An approach is provided for predictively managing or distributing charitable goods according to geographic or demographic needs. The approach involves, for example, determining need-based data, wherein the need-based data includes location-based data indicating at least one condition resulting in a need for the charitable good. The approach also involves processing the need-based data with location-based demographic data, real-time location-based contextual data, or combination thereof to compute a predicted need for the charitable good, wherein the predicted need includes a predicted geofenced boundary and a predicted time at which the predicted need is to occur. The approach further involves monitoring inventory data for the charitable good within a geographic area encompassed by the predicted geofenced boundary. The approach further involves providing an output including a recommended parameter for initiating the management or the distribution of the charitable good within the geographic area based on the predicted need and monitored inventory data.

### BACKGROUND

Currently, charity-based centers and institutions generally know how to request, process, and distribute non-monetary contributions (i.e., charitable goods such as clothing, medicine, food, etc.). For example, they may have established delivery routes to broadly distribute donated charitable goods in a given area based on an arbitrary or convenient schedule (e.g., every two weeks). These institutions often do not share information amongst themselves regarding their respective inventories. For example, one institution where a charitable need is most prevalent may have an acute shortage of a responsive charitable goods, but another organization where the need is least prevalent may have a surplus of such goods. As a result, when a charitable need arises (e.g., baby diapers), the charitable institution closest to the need may be ill prepared to effectively respond to the need (e.g., they may have an inadequate supply of responsive goods) and attempting to source such goods after the fact of the need is an efficient solution at best and in some cases, may not even be possible (e.g., during or after severe storms or natural disasters).

### SOME EXAMPLE EMBODIMENTS

Therefore, there is a need for providing a system that predictively manages or distributes charitable goods based on location-based data and demographics.

According to one embodiment, a computer-implemented method for predictive management or distribution of a charitable good comprises determining need-based data, wherein the need-based data includes location-based data indicating at least one condition resulting in a need for the charitable good. The method also comprises processing the need-based data in combination with location-based demographic data, real-time location-based contextual data, or a combination thereof to compute a predicted need for the charitable good, wherein the predicted need includes a predicted geofenced boundary and a predicted time at which the predicted need is to occur. The method further comprises monitoring inventory data for the charitable good within a geographic area encompassed by the predicted geofenced boundary. The method further comprises providing an output including a recommended parameter for initiating the management or the distribution of the charitable good within the geographic area based on the predicted need and the monitored inventory data.

According to another embodiment, an apparatus for predictive management or distribution of a charitable good comprises at least one processor, and at least one memory including computer program code for one or more computer programs, the at least one memory and the computer program code configured to, with the at least one processor, cause, at least in part, the apparatus to determine need-based data, wherein the need-based data includes location-based data indicating at least one condition resulting in a need for the charitable good. The apparatus is also caused to process the need-based data in combination with location-based demographic data, real-time location-based contextual data, or a combination thereof to compute a predicted need for the charitable good, wherein the predicted need includes a predicted geofenced boundary and a predicted time at which the predicted need is to occur. The apparatus is further caused to monitor inventory data for the charitable good within a geographic area encompassed by the predicted geofenced boundary. The apparatus if further caused to provide an output including a recommended parameter for initiating the management or the distribution of the charitable good within the geographic area based on the predicted need and the monitored inventory data.

According to another embodiment, a non-transitory computer-readable storage medium for predictive management or distribution of a good carries one or more sequences of one or more instructions which, when executed by one or more processors, cause, at least in part, an apparatus to perform determining need-based data, wherein the need-based data includes location-based data indicating at least one condition resulting in a need for the charitable good. The apparatus is also caused to perform processing the need-based data in combination with location-based demographic data, real-time location-based contextual data, or a combination thereof to compute a predicted need for the good, wherein the predicted need includes a predicted geofenced boundary and a predicted time at which the predicted need is to occur. The apparatus is further caused to perform monitoring inventory data for the good within a geographic area encompassed by the predicted geofenced boundary. The apparatus is further caused to perform providing an output including a recommended parameter for initiating the management or the distribution of the good within the geographic area based on the predicted need and the monitored inventory data.

According to another embodiment, an apparatus for predictive management or distribution of a charitable good comprises means for determining need-based data, wherein the need-based data includes location-based data indicating at least one condition resulting in a need for the charitable good. The apparatus also comprises means for processing the need-based data in combination with location-based demographic data, real-time location-based contextual data, or a combination thereof to compute a predicted need for the charitable good, wherein the predicted need includes a predicted geofenced boundary and a predicted time at which the predicted need is to occur. The apparatus further comprises means for monitoring inventory data for the charitable good within a geographic area encompassed by the predicted geofenced boundary. The apparatus further comprises means for providing an output including a recommended parameter for initiating the management or the distribution of the charitable good within the geographic area based on the predicted need and the monitored inventory data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of predictively managing or distributing charitable goods according to real-time and anticipated geographic or demographic needs, according to one embodiment;

FIG. 2 is a diagram of the components of a location platform, according to one embodiment;

FIG. 3 is a flowchart of a process for predictively managing or distributing charitable goods according to real-time and anticipated geographic or demographic needs, according to one embodiment;

FIG. 4 is a flowchart of a process for generating a map user interface for predictively managing or distributing charitable goods according to real-time and anticipated geographic or demographic needs, according to one embodiment;

FIGS. 5A through 5C are diagrams of example user interfaces for predictively managing or distributing charitable goods according to real-time and anticipated geographic or demographic needs, according to one embodiment;

FIGS. 6A and 6B are diagrams of example user interfaces for inputting need-based data and/or receiving route-based guidance to obtain needed charitable goods; according to one embodiment;

FIG. 7 is a diagram of a geographic database, according to one embodiment;

FIG. 8 is a diagram of hardware that can be used to implement an embodiment;

FIG. 9 is a diagram of a chip set that can be used to implement an embodiment; and

FIG. 10 is a diagram of a terminal that can be used to implement an embodiment.

### DESCRIPTION OF SOME EMBODIMENTS

Examples of a method, apparatus, and computer program for predictive management or distribution of charitable goods are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

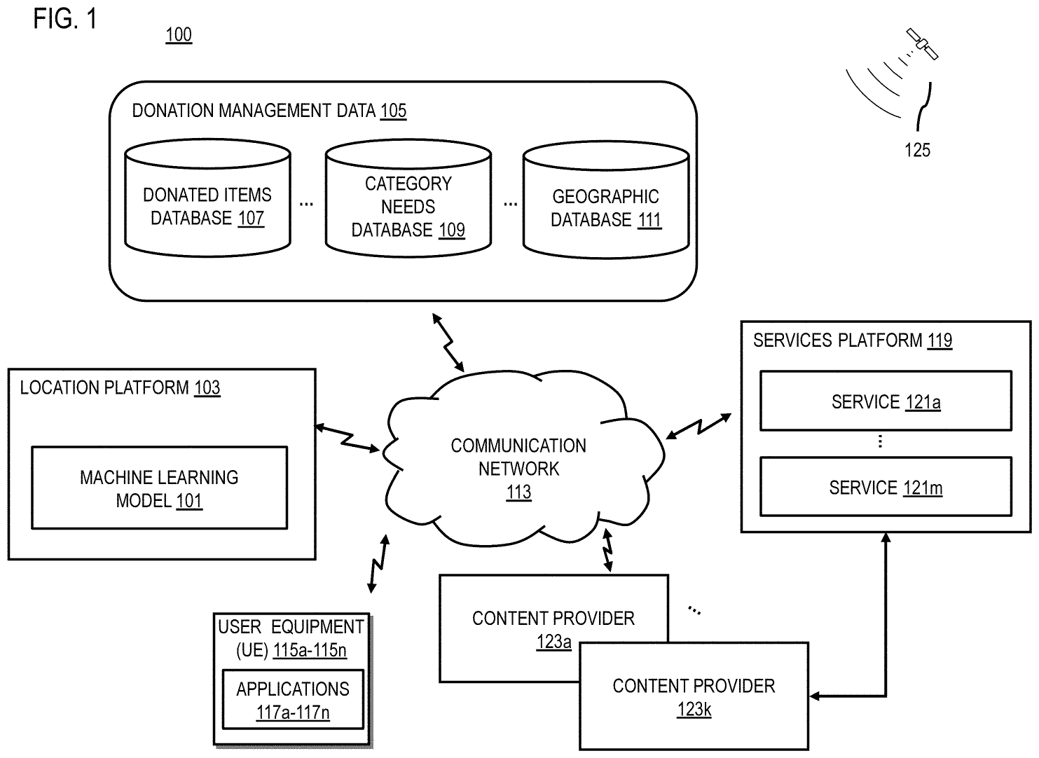

FIG. 1 is a diagram of a system capable of automatically or predictively managing or distributing charitable goods according to real-time and anticipated geographic or demographic needs, according to one embodiment. As briefly described above, currently, charity-based centers and institutions generally know how to request, process, and distribute non-monetary contributions (i.e., charitable goods such as clothing, medicine, food, etc.). For example, they may have established delivery routes to broadly distribute donated charitable goods in a given area based on an arbitrary or convenient schedule (e.g., every two weeks). In many instances, they have invested considerable human and computer resources (e.g., asset management databases) to manually track their own inventories of charitable goods. However, these centers and institutions often lack access to real-time geographic or demographic information that would enable them to know which individuals in that area (e.g., a concentration of pregnant women) need what charitable goods (e.g., baby diapers) and at what time (e.g., respective due dates). In other words, these centers and institutions often lack the ability to anticipate specific needs for items in an area in terms of timing (seasonal, school terms, weather) or population (e.g., concentration of children, elderly, etc.). Moreover, this problem is acerbated by the fact that these institutions generally do not share information amongst themselves regarding their respective inventories. For example, a Salvation Army located in a downtown location may receive a surplus of diapers, and not be aware that a suburban location—or sister organization (e.g., United Way), has an acute shortage of diapers. As a result, when a charitable need arises (e.g., baby diapers), the charitable institution closest to the need may be ill prepared to effectively respond to the need (e.g., they may have an inadequate supply of responsive goods) and attempting to source such goods after the fact is an efficient solution at best and in some cases, may not even be possible (e.g., during or after severe storms or natural disasters). Therefore, these charitable institutions face significant technical challenges to know where and when charitable goods are needed.

To address this problem, a system 100 of FIG. 1 introduces a capability to automatically or predictively manage or distribute charitable goods according to real-time and anticipated geographic or demographic needs, according to one embodiment. In one embodiment, the system 100 of FIG. 1 may include a machine learning classifier or model 101 (e.g., a support vector machine (SVM), neural network, decision tree, etc.) of the location platform 103 to process relevant donation management features or signals corresponding to donated items, category needs (e.g., baby diapers, clothing, medicine, food, etc.), and/or demographic and various need-based data (e.g., number and location of single mothers, pregnant mothers, homeless persons, poverty levels, number and location of elderly persons, opioid use, number and location of troubled youth, etc.). In one embodiment, the donation management features or signals (e.g., comprising donation management data 105) can be extracted from any data source available to the system 100 including, but not limited to, a donated items database 107, a category needs database 109, a geographic database 111, and/or any other data source, too, or system used to keep track of geographic or demographic needs.

In one embodiment, the donated items database 107 and/or other data sources for the donation management data 105 can be a repository that acts as a data warehouse that allows a user (e.g., a charitable institution) to enter donated items into a database system and to categorize and subcategorize item types (e.g., clothing, coats, baby clothing, infant supplies, footwear—shoes, boots). In one instance, the system 100 also allows a user to tag the donated items by location both virtually and physically (e.g., bar code tagging). In one instance, the location information for each item may be stored in the donated items database 107 as associated metadata. In one example, the metadata for each donated item may include additional information such as date of receipt, donor information, etc. Similarly, the category needs database 109 can hold time sensitive information relating to specific category needs (e.g., diaper shortage, winter coat driver, etc.). Further, in one embodiment, the geographic database 111 can include demographic and various need-based data as well as any user defined area-based parameters (e.g., distance from a charity facility). Though depicted as separate entities in FIG. 1, it is contemplated that the donated items database 107, the category needs database 109, and the geographic database 111 may be implemented as one or more modules of any of the components of the system 100 (e.g., the location platform 103).

In one embodiment, the system 100 uses the machine learning model 101 which learns or is trained to identify relevant correlations between the vast amount of information of the donation management data 105 mentioned above (e.g., referenced in the donated items database 107, the category needs database 109, and/or the geographic database 111). The system 100 can then use the correlation weights of the trained machine learning model 101 to predict which donated goods may be needed in a given area, where, and at what time based on their corresponding feature values indicated in the donation management data 105. In one instance, the system 100 can scan through the donation management data 105 (e.g., through the donated items database 107 and the category needs database 109) at a specified deployment interval. The system 100 can then use the trained machine learning model 101 on previously extracted donation management data to correctly tag donated items which fit the category needs criteria and any user defined area-based parameters.

For example, when a charitable institution receives a donated charitable good or determines a category need for whatever reason (e.g., in response to imminent severe storm), the system 100 can retrieve the relevant signals (e.g., any of the data fields, metadata, etc. of the donation management data 105) over a communication network 113, and then use the trained machine learning model 101 to automatically tie together donated items and real-time or even anticipated geographic or demographic needs. In this way, the system 100 can advantageously leverage the donation management data already maintained in the donated items database 107, the category needs database 109, and/or the geographic database 111 to automatically predict which charitable goods may be need, where, and at what time in a given area. In one embodiment, based on the predictions of the system 100, a charitable institution can proactively load a delivery vehicle (e.g., an institution owned vehicle such as a bus) with medicine, food, household supplies, etc. so that the charitable institution can respond to a given need as soon as possible. A minimum response time is particularly important when it comes to providing disaster relief.

In one embodiment, the system 100 enables a user (e.g., a charitable institution) to enter or to identify a receipt of donated items at a charitable facility into the donated items database 107 using one or more user equipment (UE) 115a-115n (also collectively referred to herein as UEs 115) (e.g., a client terminal, a mobile device, etc.). In one instance, the UEs 115 have connectivity to the location platform 103 via the communication network 113 and include one or more applications 117a-117n (also collectively referred to herein as applications 117). By way of example, the applications 117 may include data management applications, data entry applications, messaging applications, email applications, mapping applications, navigation applications, inventory management applications, or a combination thereof. In one embodiment, the donated items may be categorized and subcategorized in the donated items database 107 by item types (e.g., clothing, coats, baby clothing, infant supplies, footwear—shoes, boots, etc.). In one instance, the donated items may be categorized and virtually tagged using a UE 115 (e.g., a barcode scanner).

In one instance, a user (e.g., an individual or institution in need) can also enter information (e.g., time sensitive information) relating to specific category needs (e.g., diaper shortage, winter coat drive, etc.) into the category needs database 109 using a UE 115 and/or an application 117. By way of example, a hospital could have a higher than normal count/concentration of pending delivery dates during a time period and, therefore, would enter the category needs (e.g., baby diapers, baby food or formula, etc.) into the category needs database 109 using a UE 115 (e.g., a client terminal) along with the respective due dates. In one embodiment, the system 100 would track this type of spike and direct one or more charitable institutions (e.g., via an email application 117) to solicit, prepare, and deliver infant related donations accordingly.

In one embodiment, a user (e.g., a government official or a charitable institution) can enter demographic and various need-based data into the geographic database 111 using a UE 115 (e.g., a mobile device, a client terminal, etc.). For example, a volunteer carrying a UE 115 (e.g., mobile device or smartphone) may canvas an area on foot or in a vehicle to attempt to determine the number and location of homeless individuals in an area. In one instance, the geographic database 111 may be populated with demographic and various need-based data by a services platform 119 (e.g., an OEM platform) providing one or more services 121a-121m (also collectively referred to herein as services 121) and/or one or more content providers 123a-123k (also collectively referred to herein as content providers 123).

In one embodiment, the system 100 could also create a type of “Short Term Response Profile” that can enable a charitable institution to prepare for likely scenarios based on data analytics stored in or accessible via the geographic database 111. For example, such scenarios may include a government shutdown, extreme weather conditions, or a mechanical incident resulting in passengers being stranded overnight in an airport. In this instance, the system 100 could direct (e.g., via an email or messaging application 117) supplies to be quickly sent to a charitable facility near the local airport. In one embodiment, the system 100 could even match donations to passer list demographic information (e.g., number of babies on board, etc.).

In one instance, the system 100 can utilize the information in connection with real-time situation response needs such as severe weather (e.g., winter clothing) or natural disasters (e.g., emergency food supplies). In one embodiment, the system 100 processes and merges the information in connection with the services platform 119 and the services 121 (e.g., logistic services). In other words, the system 100 could consolidate and coordinate multiple logistical service providers 121, tracking systems, volunteers, physical resources (trucks), and related institutions.

In one embodiment, the system 100 can track the inventory of charitable goods across various locations (e.g., via the donated items database 107) and produce standard and predictive reports on holdings versus needs (e.g., via an application 117). In one instance, the system 100 could also calculate optimal distribution/transfer schedules and produce delivery routes accordingly (e.g., via a mapping or navigation application 117).

In one instance, the system 100 could enable institutions to use the above-mentioned data (e.g., via an email or messaging application 117) in a predictive manner in connection with targeted donation initiatives and solicitations (e.g., diapers for single mother areas, coats for the elderly in winter, school supplies for an upcoming school year in special districts, etc.).

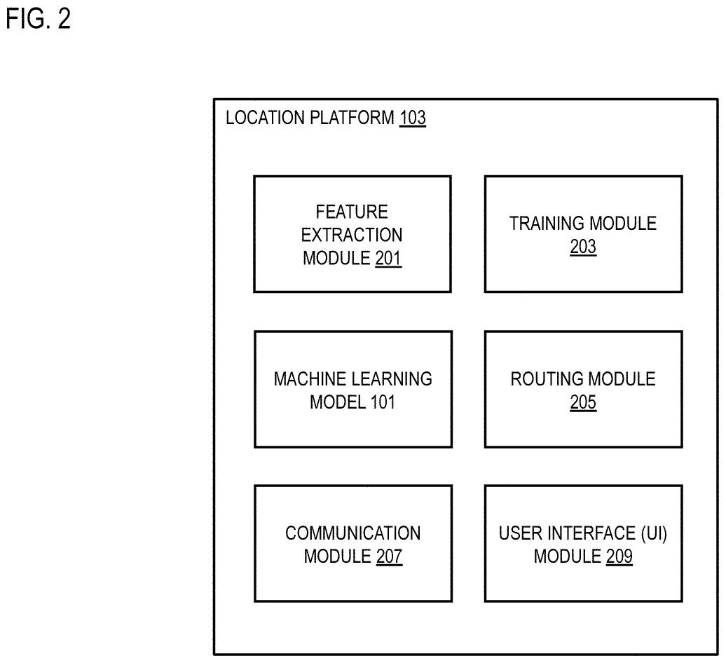

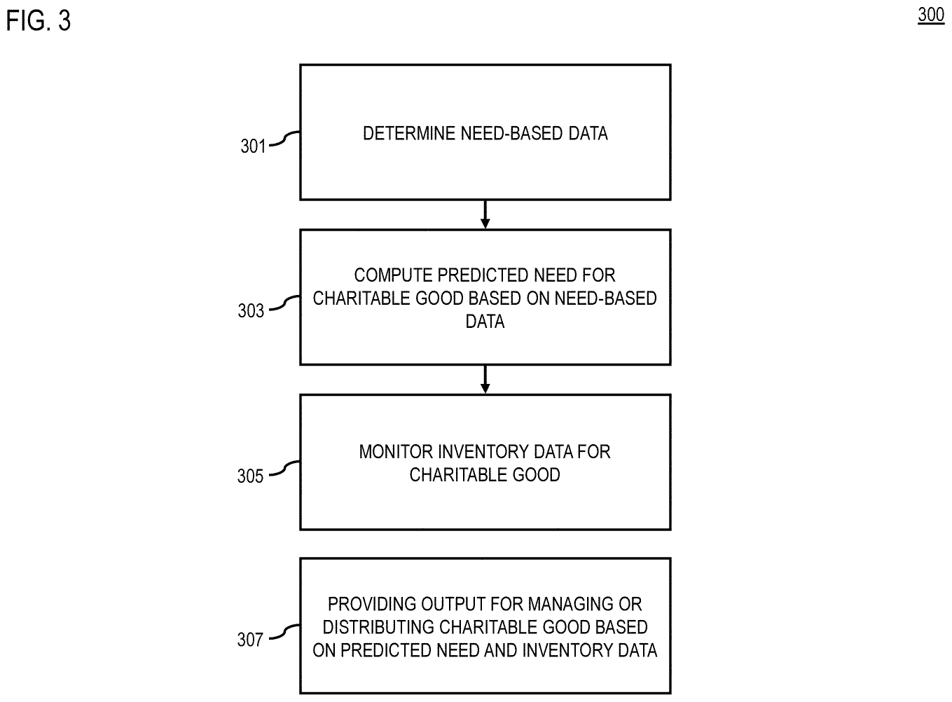

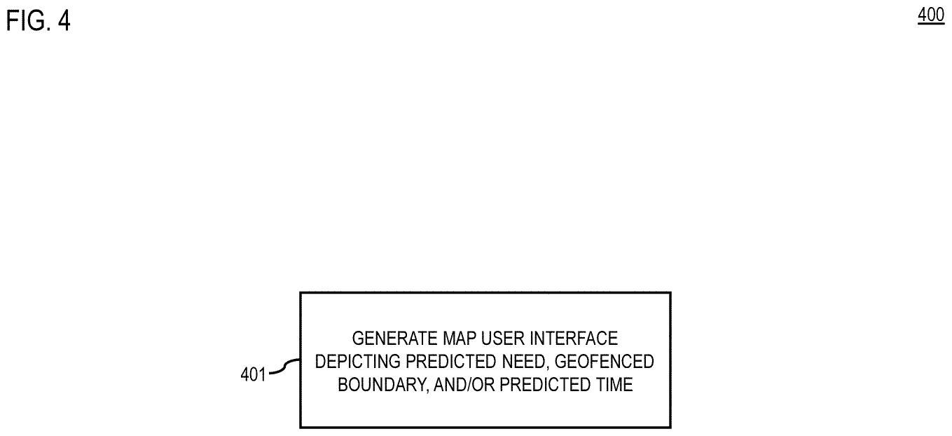

FIG. 2 is a diagram of the components of the location platform 103, according to one embodiment. By way of example, the location platform 103 includes one or more components for predictively managing or distributing charitable goods according to real-time and anticipated geographic or demographic needs. It is contemplated that the functions of these components may be combined in one or more components or performed by other components of equivalent functionality. In one embodiment, the location platform 103 includes a feature extraction module 201, a training module 203, a machine learning model 101, a routing module 205, a communication module 207, and a user interface (UI) module 209. The above presented modules and components of the location platform 103 can be implemented in hardware, firmware, software, or a combination thereof. Though depicted as separate entities in FIG. 1, it is contemplated that the location platform 103 may be implemented as a module of any of the components of the system 100. In another embodiment, the location platform 103 and/or one or more of the modules 201-209 may be implemented as a cloud-based service, local service, native application, or combination thereof. The functions of the machine learning model 101, the location platform 103 and/or the modules 201-209 are discussed with respect to FIGS. 3 and 4 below.

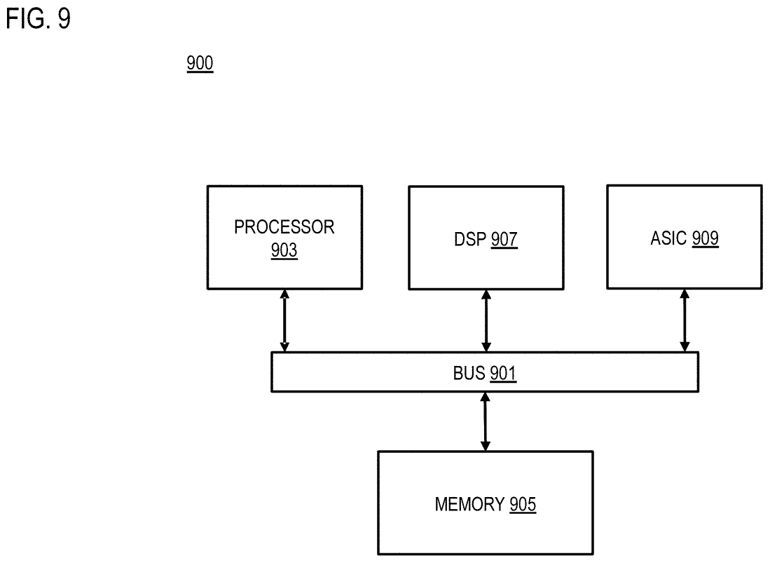

FIG. 3 is a flowchart of a process for predictively managing or distributing charitable goods according to real-time and anticipated geographic or demographic needs, according to one embodiment. In various embodiments, the location platform 103, the machine learning model 101, and/or the modules 201-209 may perform one or more portions of the process 300 and may be implemented in, for instance, a chip set including a processor and a memory as shown in FIG. 9. As such, the location platform 103, the machine learning model 101, and/or modules 201-209 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the feature extraction module 201 determines need-based data, wherein the need-based data includes location-based data indicating at least one condition resulting in a need for the charitable good. By way of example, the location-based data may indicate that a severe winter storm is imminent in an area that will likely result in the need for winter coats, blankets, etc. In other words, the location-based data may be based on real-time geographic demand. In one instance, the feature extraction module 201 may determine or retrieve the need-based data based on information or data (e.g., historical data and/or real-time information) stored in or accessible via the category needs database 109, the geographic database 111, or a combination thereof. In one embodiment, extracting comprises processing the donation management data 105 as described above to convert the data into a format suitable for input into the trained machine learning model 101. For example, the features or data items can be converted into an input vector or matrix for processing by the machine learning model 101. In addition, the feature extraction module 201 can also normalize or convert the extracted data fields (e.g., donated items) into a common taxonomy or dictionary of terms (e.g., clothing, food, medicine, etc.).

In one embodiment, the need-based data includes demographic and various need-based data (e.g., stored in or accessible via the geographic database 111). For example, the need-based data may include a number and location of single mothers, a number and location of babies (or expected babies), a number and location of homeless persons, a poverty level, a number and location of elderly people, a level of drug use, a number and location of troubled youths, or a combination thereof. In one instance, the feature extraction module 201 may determine or retrieve the location-based data based, at least in part, on metadata derived from a location of a UE 115 (e.g., a mobile device) used to enter the category need and/or the demographic and various need-based data. In another example, the need-based data may include not just the number and location of homeless people in an area, but also the number and the location of individuals that need medicine (e.g., insulin) as well as the times at which they will need the medicine (e.g., per a prescription, a schedule, etc.).

In step 303, the training module 203 processes the need-based data in combination with location-based demographic data, real-time location-based contextual data, or a combination thereof to train the machine learning model 101 to compute a predicted need for the charitable good, wherein the predicted need includes a predicted geofenced boundary and a predicted time at which the predicted need is to occur.

In one embodiment, the training of the machine learning model 101, for instance, enables the machine learning model 101 to use a predetermined set of weights, correlations, relationships, etc. among the input features to output where and when a donated item is needed in response to a real-time or anticipated geographic or demographic need. In one instance, the predicted where and when may be based on a threshold probability or range. In one embodiment, the steps 301 and 303 are based on generating or obtaining a set of ground truth data about known demographic and various needs and responsive donated items. In one instance, the ground truth data can include donated management data 105 such as that described above.

By way of example, in the instance where the location-based demographic data (e.g., stored in the geographic database 111) includes the number and the location of pregnant women in an area, the machine learning model 101 can be trained to classify or predict the need for diapers at the various locations within a predicted geofenced boundary at the various corresponding due dates. In one instance, the predicted geofenced boundary may be a threshold distance from which a need recipient or a concentration of need recipients can easily obtain a charitable good. For example, the threshold distance may be a walking distance, a distance easily accessible by public transportation, a short driving distance, or a combination thereof. In another instance, the training module 203 may train the machine learning module 101 such that the predicted geofenced boundary may be scaled to a national or even an international level. For example, the predicted geofenced boundary may be based on needs-based data associated with one or more other countries to enable a charitable institution to prioritize and to take distribution actions in those areas (e.g., by loading planes with charitable goods to assist with disaster relief).

In one embodiment, the real-time location-based contextual data may include weather or climate-based data (e.g., related to a hurricane) so that the training module 203 can train the machine learning model 101 to predict where and when emergency related supplies will be needed in response to real-time or anticipated needs. In other words, the training module 203 can train the machine learning module 101 using the need-based data, location-based demographic data, real-time location-based contextual data, or the combination thereof to predict where and when a charitable good will be needed in response to a real-time or anticipated geographic or demographic need.

In one embodiment, the training module 203 and/or the machine learning model 101 prioritizes the management or the distribution of the charitable good among a plurality of other charitable goods based on the predicted time of the predicted need for the charitable good. By way of example, the training module 203 and/or the machine learning model 101 may prioritize or weight winter coats versus baby food or medicine in a response to weather or climate data indicative of a severe winter storm. In one embodiment, the machine learning model 101 may also or further prioritize or weight the correlation between winter coats and individuals that would likely benefit most by receiving the winter coats first (e.g., young and the elderly individuals, individuals that are furthest away or would have the most difficulty reaching the charitable good, etc.).

In step 305, the feature extraction module 201 monitors inventory data for the charitable good within a geographic area encompassed by the predicted geofenced boundary. By way of example, the inventory data may include a charitable good type organized by categories and subcategories (e.g., clothing, coats, baby clothing, infant supplies, footwear—shoes, boots, etc.), the number or amount of each charitable good, and the location. In one embodiment, the feature extraction module 201 may monitor the inventory in real time or substantially real time based on virtual and/or physical tagging (e.g., bar code tagging) of such items. By way of example, the geographic area may be based on a short driving distance from a charity facility, a distribution center, a warehouse, a staging facility, or the like such that the needed charitable goods may be quickly and efficiently distributed to the individuals in need. In one embodiment, the feature extraction module 201 scans through the data sources of the donation management data 105 (e.g., the donated items database 107) at a specified deployment interval to ensure that the determined donation management data is up-to-date.

In step 307, the communication module 207 provides an output including a recommended parameter for initiating the management or the distribution of the charitable good within the geographic area based on the predicted need and the monitored inventory data. In one embodiment, the output includes a report of the monitored inventory against the predicted need of the charitable good (i.e., holdings versus needs). For example, the output provided by the communication module 207 (e.g., via an application 117) could quickly inform a user whether there is an acute shortage or a surplus of a predicted charitable good at a charitable facility and provide one or more recommended actions to take in response (e.g., please donate to Center X or please donate to Center Y if you were going to donate to Center X). By way of example, the recommended parameter may include any user defined-area based parameters (e.g., a threshold distance from a charity center).

In one embodiment, the routing module 205 can compute a distribution route for distributing the charitable good within the geographic area to the predicted geofenced boundary based on the monitored inventory data and the predicted time of the predicted need, wherein the recommend parameter includes the distribution route. By way of example, the routing module 205 may take into consideration such factors as real-time or historic traffic, parking availability, weather, etc. when computing the distribution route. In other words, the routing module 205 can compute the distribution route based on any factors that may enable or prevent the maximum efficient distribution of the needed goods.

In one embodiment, wherein the recommended parameter of the output includes a location of a charitable center within a predetermined threshold distance of a donor, the communication module 207 can transmit the output to a device of a donor (e.g., a mobile device, a smartphone, a computer, etc.), wherein the output further identifies the charitable good corresponding to the predicted need (e.g., winter coats in response to a severe winter storm). By way of example, the predetermined threshold distance between a charitable center and a donor may be a distance that is easily traveled by a donor to drop off the needed good or by a representative of the charitable center to pick up the needed good (e.g., a short car drive away). In one instance, wherein the recommend parameter of the output includes a location of a charitable center in or within a predetermined threshold distance of the geofenced boundary from which a need recipient can obtain the charitable good, the communication module 207 can transmit the output to a device of a need recipient (e.g., a mobile phone). By way of example, the predetermined threshold distance between the charitable center and the geofenced boundary may be a walking distance, a distance easily accessible by public transportation, a short driving distance, or a combination thereof (i.e., a threshold distance that is easily traveled by a need recipient).

In one instance, wherein the real-time location-based contextual data includes an emergency condition (e.g., a severe weather storm), the training module 203 can create a response profile (e.g., a “Short Term Response Profile”) for an emergency condition based on the output, wherein the response profile can be initiated on an occurrence or a recurrence of the emergency condition. By way of example, in instances of a government shutdown, extreme weather, or an incident that results in passengers being stranded overnight at an airport, the response profile created by the training module 203 could be used to train the machine learning model 101 so that the machine learning model 101 can predict which chartable goods are needed and where they are located so that they can be quickly sent from one charitable facility to another near the local airport. In one instance, the response profile may even be used to train the machine learning model 101 to match donations to passenger list demographic information (e.g., number of babies on board, etc.).

FIG. 4 is a flowchart of a process for generating a map user interface for predictively managing or distributing charitable goods according to real-time and anticipated geographic or demographic needs, according to one embodiment. In various embodiments, the location platform 103, the machine learning model 101, and/or the modules 201-209 may perform one or more portions of the process 400 and may be implemented in, for instance, a chip set including a processor and a memory as shown in FIG. 9. As such, the location platform 103, the machine learning model 101, and/or modules 201-209 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps. In one embodiment, the process 400 describes additional steps that can be performed in combination with the process 300 described above.

In step 401, the UI module 209 generates a map user interface depicting a representation of a predicted need, a predicted geofenced boundary, a predicted time, or a combination thereof. By way of example, the map user interface may include a representation of a predicted need (e.g., diapers) located throughout an area and the representation may be color coded based on a predicted time of need (e.g., red for an immediate need, yellow for a need in a week, and green for a need in 2-3 weeks). In one embodiment, the UI module 209 also updates the map user interface as the predicted need, the predicted geofenced boundary, the predicted time, or a combination thereof is updated. In the instant example, once diapers are distributed to the individuals with an immediate need their representations may be removed from the map user interface and the color coding of the remaining need recipients may be updated accordingly (e.g., green to yellow and yellow to red).

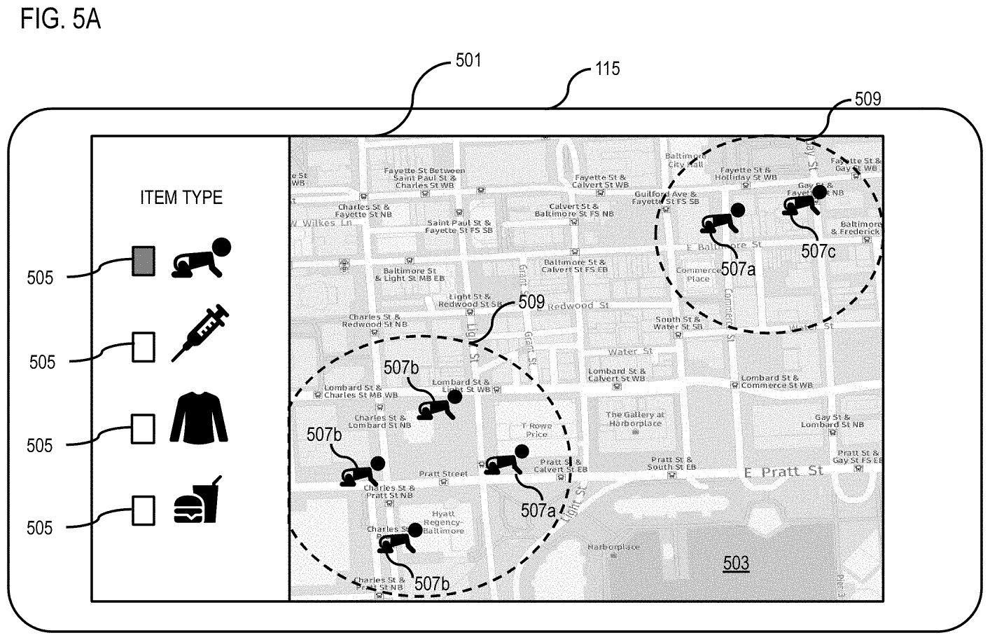

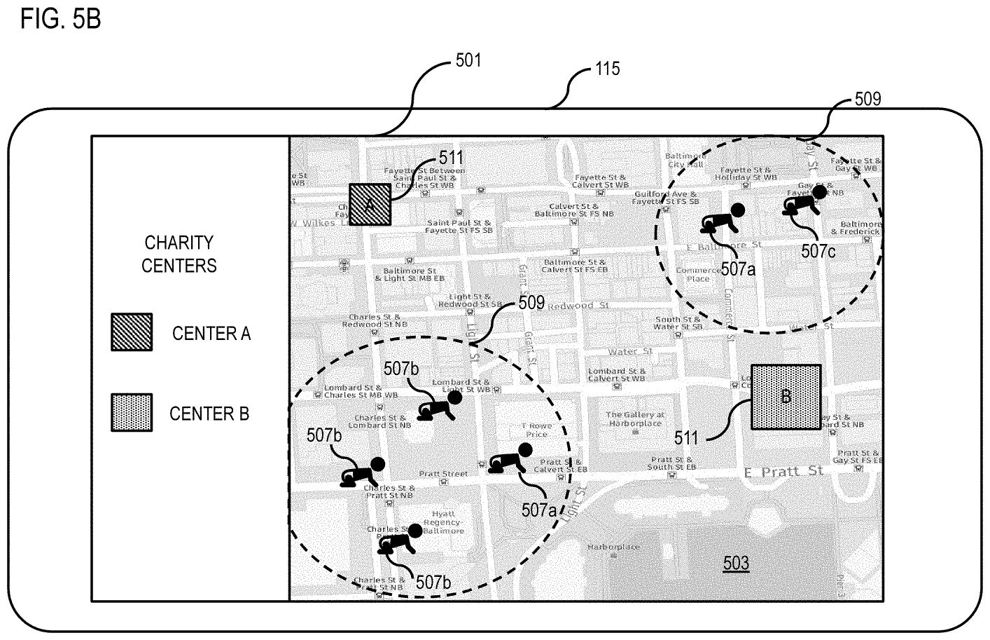

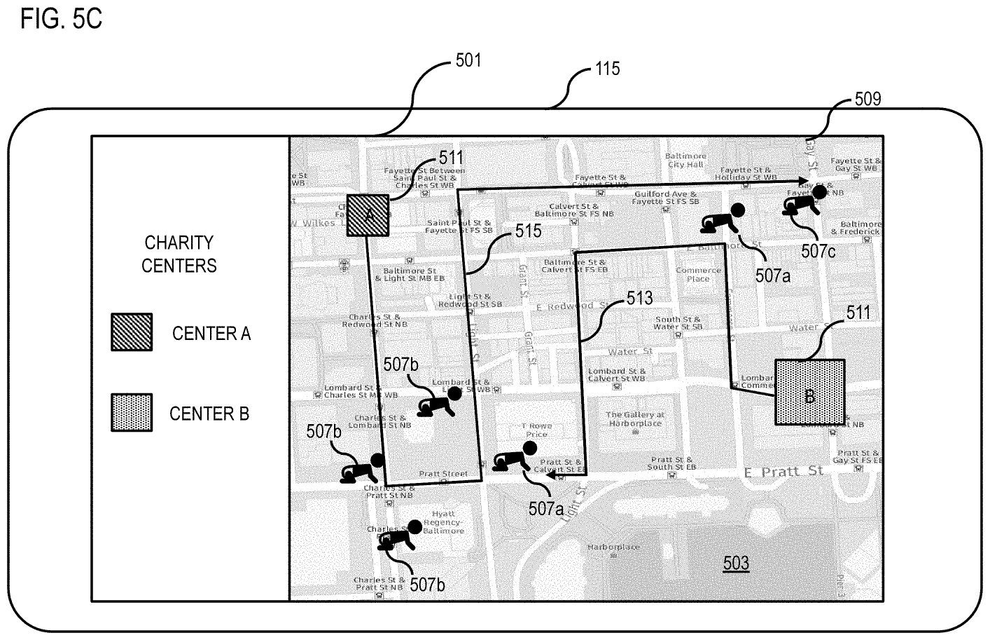

FIGS. 5A through 5C are diagrams of example user interfaces for predictively managing or distributing charitable goods according to real-time and anticipated geographic or demographic needs, according to one embodiment. Referring to FIG. 5A, a UI 501 (e.g., a mapping application 117) is generated for a UE 115 (e.g., a mobile device, a computer, etc.) that enables a user (e.g., a charitable institution) to determine need-based data for an area 503 (e.g., a city center, an area proximate to a charity facility, etc.). In one embodiment, the system 100 generates the UI 501 such that it includes inputs 505 that can enable a user (e.g., via a touch, a tap, a gesture, etc.) to view one or more various charitable good category needs (e.g., baby diapers, medicine, clothing, food and water, etc.) and location-data associated with each need. In one instance, the system 100 generates the UI 501 such that a user can view the one or more categories simultaneously or separately. For example, a charitable institution may want a global overview of the charitable good needs in an area due to a severe winter storm. Alternatively, a charitable institution may want a selective view of a specific charitable need in connection with a forthcoming targeted donation initiative or solicitation (e.g., diapers for single mothers). In one embodiment, the system 100 generates the UI 501 such that a user may also interact with the UI 501 via a voice-command, a digital pen, etc.

In this example use case, a user (e.g., a charitable institution) is interested in managing and prioritizing the distribution of diapers, as depicted by the charitable need icons 507a-507c (also collectively referred herein as charitable need icons 507). In one embodiment, the system 100 can represent each charitable need icon 507 in the UI 501 based on a single person in need (e.g., an expecting mother) or based on a concentration of similarly situated individuals (e.g., a group of expecting mothers). In one instance, the system 100 generates the UI 501 such that a user can modify or tailor the specific numeric representation of each charitable need icon 507 based on her/his inquiry or purpose. In one embodiment, the system 100 represents each charitable need icon 507 in the UI 501 based on the actual location of an individual or a concentration of individuals in need (e.g., based on the location of a user's mobile device) or the system 100 may represent the location based on an approximate location in consideration of personal or local privacy concerns or regulations. In this example use case, each charitable need icon 507 represents an approximate location of a concentration of expecting mothers.

In one instance, the system 100 processes the need-based data in combination with the location-based demographic data, real-time location-based contextual data, or a combination thereof to compute a predicted need for the charitable good (e.g., baby diapers) including a predicted geofenced boundary 509 and a predicted time at which the predicted need is to occur (e.g., a number of days, weeks, etc.). By way of example, the system 100's representation of the predicted geofenced boundary 509 in the UI 501 may assist a user (e.g., a charitable institution) to visualize why the system 100 is distributing charitable items from one inventory center or another in response to the need. In one instance, the predicted geofenced boundary 509 may be based on a threshold distance from which a need recipient can easily obtain the charitable good (e.g., a walking distance, a distance accessible by public transportation, etc.). In one embodiment, the system 100 can represent the charitable need icons 507 in the UI 501 using a color-coding such that a charitable need icon 507 is rendered red for individuals or locations where the predicted need is most imminent, yellow where the predicted need is within a short time, and green where the predicted need is some time in the future. In another instance, the system 100 can represent a charitable icon 507 in the UI 501 using any symbols or coding that differentiates among the respective predicted times (e.g., size, shape, color, etc.). In this example use case, the charitable need icons 507a are represented as red, the charitable need icons 507b as yellow, and the charitable need icons 507c as green.

In one embodiment, the system 100 monitors the inventory data for the chartable good (e.g., baby diapers) within the geographic area 503 encompassed by the predicted geofenced boundaries 509. In one instance, the system 100 can render the location and the inventory data using a symbol 511 such that a user (e.g., a charitable institution) can quickly view which charity facilities have more inventory of a charitable good (e.g., baby diapers) at a given time, as depicted in FIG. 5B. In this example, a use can quickly see that the inventory at the Center B is much greater than the inventory at the Center A. In one embodiment, the system 100 can automatically initiate targeted donation solicitations in response to the inventory of a chartable good falling below a threshold value. For example, in this instance, the system 100 has already initiated a targeted donation solicitation based on the current inventory levels at the Center A.

In one instance, the system 100 provides an output via the UI 501 including a recommended parameter for initiating the management or distribution of the charitable good within the geographic area 503 based on the predicted need (e.g., baby diapers) and the monitored inventory data (e.g., symbols 511). In this example use case, the recommended parameter includes the distribution routes 513 and 515, as depicted in FIG. 5C. In one embodiment, the system 100 can provide the output including the distribution routes 513 and 515 to a driver of a delivery vehicle via the UI 501 or the system 100 may provide the information directly to an autonomous delivery vehicle via a UE 109 (e.g., an embedded navigation system). In this example use case, the system 100 computes the distribution route 513 from the Center B to the individuals in most immediate need (e.g., charitable need icons 507a) because it has the most inventory in the area 504 and to allow the Center A additional time to receive the incoming baby diapers in response to the targeted solicitation before its inventory is fully depleted. Once the system 100 determines that the inventory of Center A has risen above the critical threshold level (e.g., in response to the recent baby diaper drive), the system 100 can compute the distribution route 515 from the Center A to the remaining individuals such that individuals represented by charitable need icons 507b (yellow) receive the baby diapers before the individuals represented by the charitable needs icon 507c (green). In one embodiment, as the needs of the individuals are met, the system 100 can update the various representations in the UI 501. For example, by removing the charitable need icons 507a and changing the charitable need icons 507b to 507a and 507c to 507b. Consequently, the UI 501 generated by the system 100 can able a user (e.g., a charitable institution) to quickly view the need, the status, or the completion of targeted solicitations, collections, tracking, and/or distributions of charitable goods in the area 503.

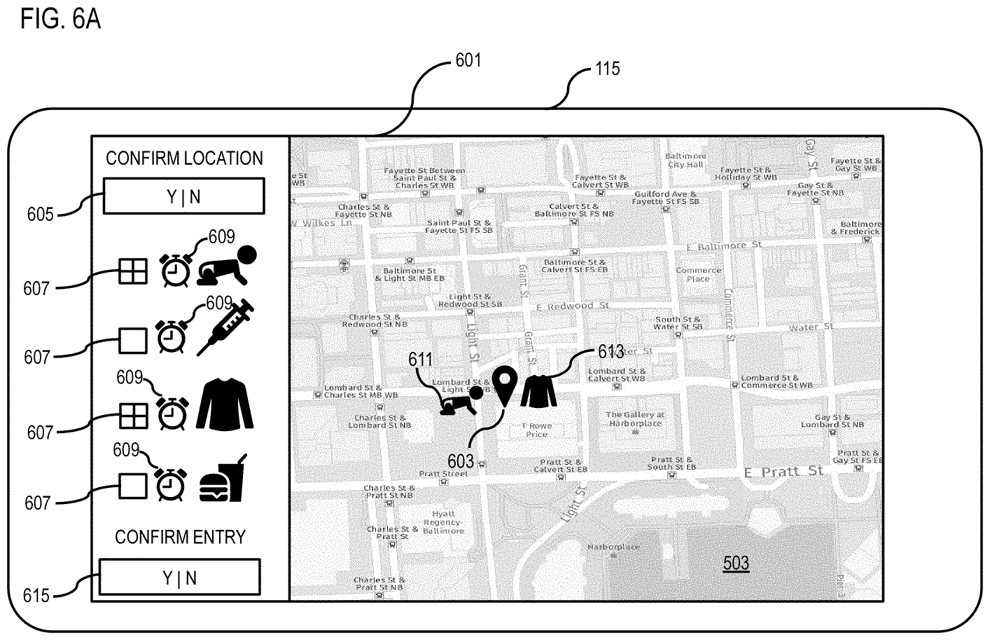

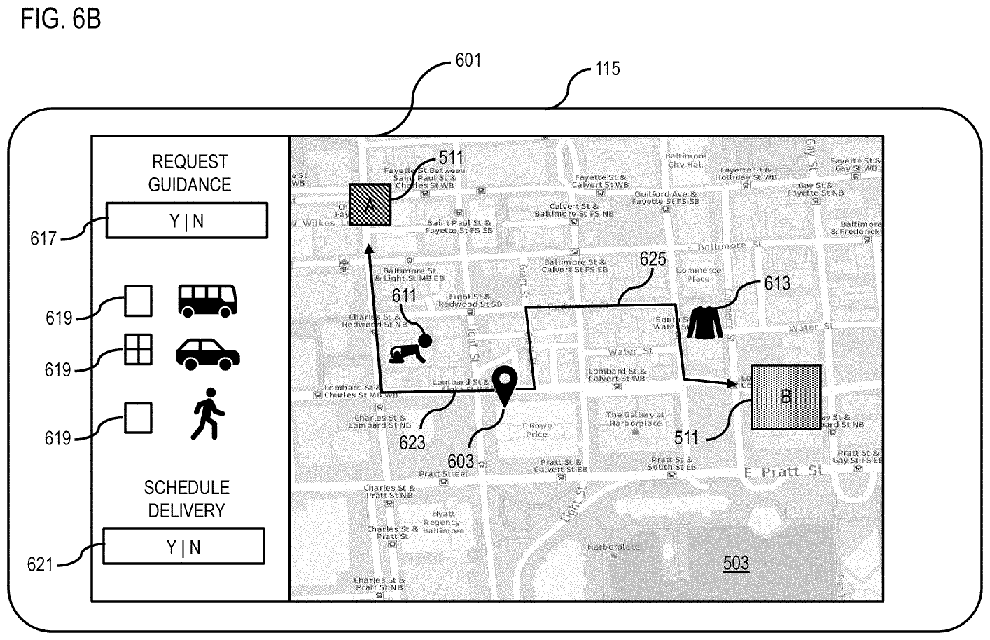

FIGS. 6A and 6B are diagrams of example user interfaces for inputting need-based data and/or receiving route-based guidance to obtain needed charitable goods; according to one embodiment. Referring to FIG. 6A, the system 100 can generate the UI 601 (e.g., a mapping application 117) such that a user (e.g., a single mother in need) can identify one or more charitable good categories or items that she currently needs or anticipates needing in the near future (e.g., due to giving birth, dropping temperatures, etc.). In one embodiment, the system 100 may first ask that a user confirm her/his location 603 using the input 605. In one instance, the system 100 can generate the UI 601 such that a user can then use the inputs 607 to select which charitable good category items she/he would like to request (e.g., baby diapers, medicine, clothing, food and water, etc.) and then use the inputs 609 to indicate the time or the predicted time of the need or anticipated need, respectively. In this use case example, the user may request baby diapers (icon 611) for an immediate need and the clothing (icon 613) for an anticipated need (e.g., the change from fall to winter). By way of example, the system 100 may render the baby diaper icon 611 red and the clothing icon 613 green in the UI 601. In another use case, the user may request the baby diapers for a few months from now (e.g., after giving birth) and the clothing now due to losing her home and contents in a fire. In this instance, the system 100 may render the baby diaper icon 611 green and the clothing icon 613 red in the UI 601. Further, in one embodiment, the system 100 may generate the UI 601 such that it also includes an input 615 to enable the user to confirm the need-based data before submitting the request to the system 100 to ensure maximum efficiencies in management and distribution of the charitable goods in the area 503.

In one embodiment, the system 100 can also generate the UI 601 such that a user may obtain guidance information from her/his location to a nearby charity center (e.g., Centers A and B) based on the needed charitable good, preferred or available mode of transportation, or a combination thereof, as depicted in FIG. 6B. In one instance, the system 100 can generate the UI 601 such that it includes an input 617 to request guidance to the appropriate charity facility. In one embodiment, the system 100 can further generate the UI 601 with inputs 619 so that the user can specify a preferred or available mode of transportation. In one embodiment, the system 100 may generate the UI 601 such that it includes an input 621 to enable a user to schedule a delivery of needed charitable good (e.g., in cases where the user cannot travel). In this example use case, following the first example described with respect to FIG. 6A, the system 100 renders a guidance route 623 for the user to immediately pick up baby diapers at Center A and a guidance route 625 for the user to pick up the winter clothing from Center B in the near future. In this example, the system 100 may generate the route 625 based on expected construction between the user's location and the Center B at or about the time that the user is predicted to need and/or pick up the winter clothing.

Returning to FIG. 1, in one embodiment, the donated items database 107 can store information regarding donated item counts, category and subcategory types (e.g., clothing, coats, baby clothing, infant supplies, footwear—shoes, boots), etc. In one instance, the category needs database 109 can store information (e.g., time sensitive information) relating to specific category needs (e.g., diaper shortages, winter coat drive, etc.). As mentioned above, though depicted as separate entities in FIG. 1, it is contemplated that the donated items database 107, the category needs database 109, and the geographic database 111 comprising the donation management data 105 may be implemented as one or more modules of any of the components of the system 100 (e.g., the location platform 103). In one embodiment, the information may be any of multiple types of information that can provide means for the location platform 103 to predictively manage or distribute charitable goods according to real-time and anticipated geographic or demographic needs. In another embodiment, the donated items database 107 and/or the category needs database 109 may be in a cloud, a UE 115, or a combination thereof.

In one embodiment, a UE 115 can be associated with a charitable institution (e.g., a mobile device, a client terminal, etc.), an individual in need (e.g., a mobile phone), or integrated in a standard or an autonomous delivery vehicle (e.g., an embedded navigation system). By way of example, the UEs 115 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 115 can support any type of interface to the user (such as “wearable” circuitry, etc.). Also, the UEs 115 may be configured to access the communication network 113 by way of any known or still developing communication protocols. In one embodiment, the UEs 115 may include the location platform 103 to predictively manage or distribute charitable goods according to real-time and anticipated geographic or demographic needs.

In one embodiment, the location platform 103 performs the process for predictively managing or distributing charitable goods according to real-time and anticipated geographic or demographic needs as discussed with respect to the various embodiments described herein. In one embodiment, the location platform 103 can be a standalone server or a component of another device with connectivity to the communication network 113. For example, the component can be part of an edge computing network where remote computing devices (not shown) are installed along or within proximity of an intended destination (e.g., a charity facility).

In one embodiment, the location platform 103 has connectivity over the communication network 113 to the services platform 119 that provides the services 121. By way of example, the services 121 may also be other third-party services and may include mapping services, navigation services, logistic services, distribution services, inventory management services, personnel or and/or volunteer management services, communication services (e.g., donation initiatives and solicitations, email blasts, etc.), notification services, social networking services, content provisioning services (e.g., audio, video, images, etc.), application services, storage services, contextual information determination services (e.g., weather, news, etc.), location-based services, etc. In one embodiment, the services 121 may include tracking services that can track inventory using one or more satellites 125 (e.g., based on geographic coordinates).

In one embodiment, content providers 123a-123k (also collectively referred to herein as content providers 123) may provide content or data to the machine learning model 101, the location platform 103, donated items database 107, the category needs database 109, the geographic database 111, the UEs 115, the applications 117, the services platform 119, and the services 121. By way of example, the content or data may include items, counts, categories, and subcategories of donated items; categories and subcategories of needed charitable goods (e.g., based on historical, real time, and/or anticipated needs), need-based data, geographic or demographic data (e.g., areas of low income housing, concentrations of homeless, etc.); optimal distribution/transfer schedules; content or data that may affect delivery routes; etc. The content provided may be any type of content, such as numerical content, map content, contextual content, audio content, video content, image content, etc. In one embodiment, the content providers 123 may also store content associated with the machine learning model 101, the location platform 103, the donation management data 105 (e.g., the donated items database 107, the category needs database 109, the geographic database 111), the UEs 115, the applications 117, the services platform 119, and/or the services 121. In another embodiment, the content providers 123 may manage access to one or more repositories of data, and offer a consistent, standard interface to data, such as repositories of the donated items database 107, the category needs database 109, and/or the geographic database 111.

In one embodiment, the location platform 103 may be a platform with multiple interconnected components. By way of example, the location platform 103 may include multiple servers, intelligent networking devices, computing devices, components and corresponding software for predictively managing or distributing a charitable goods according to real-time and anticipated geographic or demographic needs. In addition, it is noted that the location platform 103 may be a separate entity of the system 100, a part of the services platform 119, the services 121, or the content providers 123.

The communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the geographic database 111 can store information regarding geographic or demographic needs data (e.g., a number and location of single mothers, a a number and location of homeless individuals, poverty levels, a number and location of elderly persons, levels of opioid use, a number and location of troubled youths, etc.). The geographic database 111 may also include routing and traffic information. In one instance, the geographic database 111 may include airplane passenger list demographic information (e.g., the number of babies onboard). In one embodiment, the geographic database 111 may include climate or weather-based data for an area or region. In one instance, the geographic database 111 may include parking availability data at or near a charity center, a charity center's operating hours, etc. The information may be any of multiple types of information that can provide means for predictively managing or distributing charitable goods according to real-time and anticipated geographic or demographic needs. In another embodiment, the geographic database 111 may be in a cloud, a UE 115, or a combination thereof.

By way of example, the location platform 103, the donated items database 107, the category needs database 109, the geographic database 111, the UEs 115, the applications 117, the services platform 119, the services 121, the content providers 123, and the satellites 125 communicate with each other and other components of the communication network 113 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

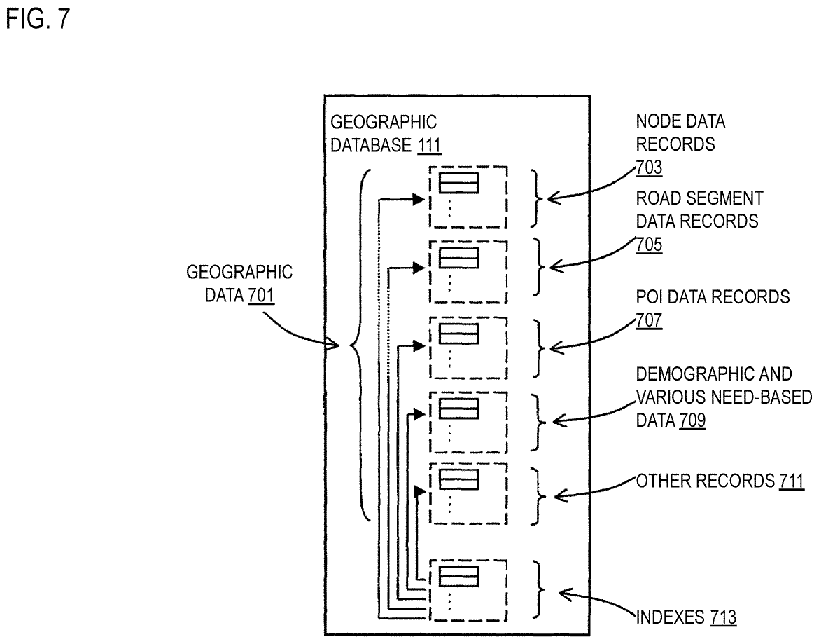

FIG. 7 is a diagram of the geographic database 111, according to one embodiment. In one embodiment, real-time and anticipated geographic or demographic needs-based data used by the system 100 with respect to predictively managing or distributing charitable goods according to real-time and anticipated geographic or demographic needs can be stored, associated with, and/or linked to the geographic database 111 or data thereof. In one embodiment, the geographic or map database 111 includes geographic data 701 used for (or configured to be compiled to be used for) mapping and/or navigation-related services, such as charity facility locations, route information, service information, on-street parking probability information, location sharing information (e.g., a person in need), speed sharing information, and/or geospatial information sharing, according to exemplary embodiments. For example, the geographic database 111 includes node data records 703, road segment or link data records 705, POI data records 707, demographic and various need-based data 709, other data records 711, and indexes 713, for example. More, fewer or different data records can be provided. In one embodiment, the other data records 711 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. In one embodiment, the POI data records 707 may also include information on charitable-based institutions (e.g., Salvation Army, United Way, etc.) or shelters (e.g., locations, operating days/hours, etc.), traffic controls (e.g., stoplights, stop signs, crossings, etc.), driving restrictions (e.g., speed, direction of travel, etc.), parking restrictions (e.g., side of street, day of week, etc.), or a combination thereof.

In one embodiment, geographic features, e.g., two-dimensional or three-dimensional features, are represented using polygons, e.g., two-dimensional features, or polygon extrusions, e.g., three-dimensional features. For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in geographic database 111.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes, e.g., used to alter a shape of the link without defining new nodes.

“Oriented link”—A link that has a starting node (referred to as the “reference node”) and an ending node (referred to as the “non-reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary, e.g., a hole or island. In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In exemplary embodiments, the road segment data records 705 are links or segments representing roads, streets, or paths, as can be used in the determining boundaries of the service areas for each shared vehicle operator (or other relevant operator restrictions which may have an impact on parking) (e.g., link-based restrictions). The node data records 703 are end points corresponding to the respective links or segments of the road segment data records 705. The road link data records 705 and the node data records 703 represent a road network, such as used by standard or autonomous delivery vehicles and/or other entities. Alternatively, the geographic database 111 can contain path segment and node data records or other data that represent pedestrian paths, bicycle paths, or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs (e.g., general or personal POIs), such as homes, residences, charity institutions or facilities, warehouses, gasoline stations, hotels, restaurants, museums, stadiums, offices, automobile dealerships, auto repair shops, buildings, stores, parks, etc. The geographic database 111 can include data about the POIs and their respective locations in the POI data records 707. In one instance, the POI data records 707 can include information regarding a charitable facility's operating days/hours, charitable goods drop-off and pick up policies and procedures, etc. The geographic database 111 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 111 can also include demographic and various need-based data 709. By way of example, the demographic and various need-based data may include a number and location of single mothers, pending delivery dates, a number and location of homeless persons, poverty levels in an area, a number and location of elderly, levels of opioid use, a number and location of troubled youths, etc. In one embodiment, the demographic and various-need based data 709 may be based on historic data, time sensitive information, real time geographic demand, or a combination thereof. In one instance, the demographic and various need-based data 709 may include the number and location of homeless individuals that require insulin as well as the times at which such medication should be administered. In another example, the demographic and various need-based data 709 may include the number of babies that are on a plane at a local airport. By way of example, the demographic and various need-based data 709 can be associated with one or more of the node data records 703, road segment data records 705, and/or POI data records 707 to support predictively managing or distributing charitable goods according to real-time and anticipated geographic or demographic needs.

In one embodiment, the indexes 713 may improve the speed of data retrieval operations in the geographic database 111. In one embodiment, the indexes 713 may be used to quickly locate data without having to search every row in the geographic database 111 every time it is accessed. For example, in one embodiment, the indexes 713 can be a spatial index of the polygon points associated with stored feature polygons.

In one embodiment, the geographic database 111 can be maintained by a content provider 123 in association with the services platform 119, e.g., a map developer. The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., a standard or autonomous deliver vehicle) and/or travel with a UE 115 along roads throughout the geographic region to observe features and/or record information about them, for example. Also, remote sensing, such as aerial or satellite photography, can be used (e.g., using one or more satellites 125).

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for predictively managing or distributing charitable goods according to real-time and anticipated geographic or demographic needs may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

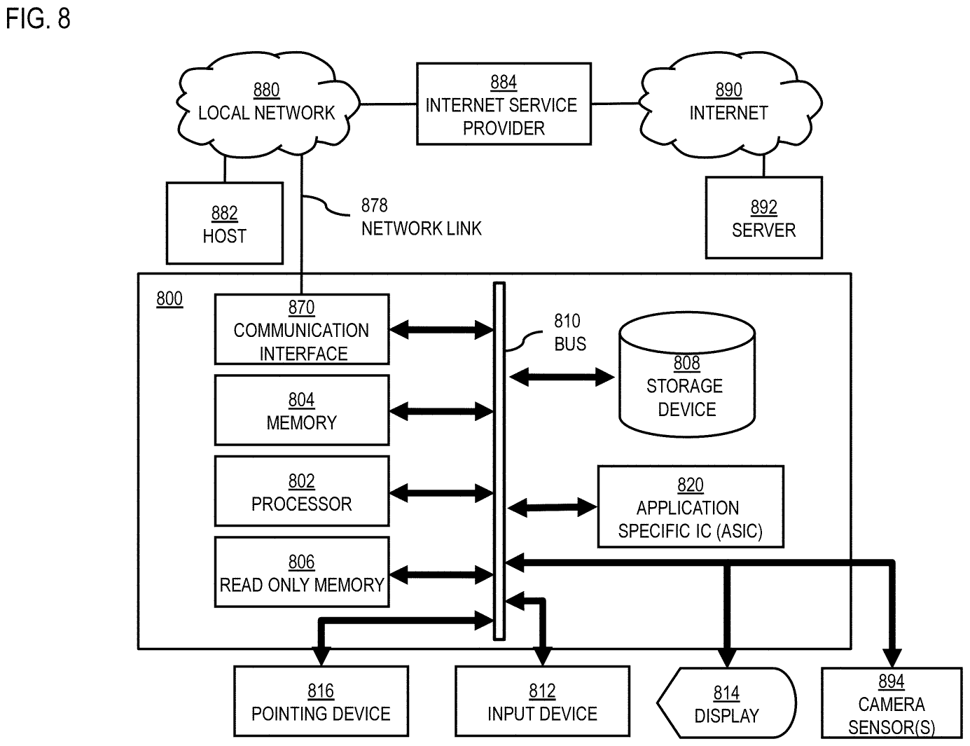

FIG. 8 illustrates a computer system 800 upon which an embodiment may be implemented. Computer system 800 is programmed (e.g., via computer program code or instructions) to manage or distribute charitable goods according to real-time and anticipated geographic or demographic needs as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to predictively managing or distributing charitable goods according to real-time and anticipated geographic or demographic needs. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random-access memory (RAM) or other dynamic storage device, stores information including processor instructions for predictively managing or distributing charitable goods according to real-time and anticipated geographic or demographic needs. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for predictively managing or distributing charitable goods according to real-time and anticipated geographic or demographic needs, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 113 for predictively managing or distributing charitable goods according to real-time and anticipated geographic or demographic needs.

The term non-transitory computer-readable medium is used herein to refer to any medium that participates in providing information to processor 802, including instructions for execution. Such a medium may take many forms, including, but not limited to, non-volatile media, volatile media and transmission media. Non-volatile or non-transitory media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

In one embodiment, a non-transitory computer-readable storage medium carrying one or more sequences of one or more instructions (e.g., computer code) which, when executed by one or more processors (e.g., a processor as described in FIG. 5), cause an apparatus (e.g., the vehicles 101, the UEs 105, the location platform 103, etc.) to perform any steps of the various embodiments of the methods described herein.

FIG. 9 illustrates a chip set 900 upon which an embodiment may be implemented. Chip set 900 is programmed to manage or distribute charitable goods according to real-time and anticipated geographic or demographic needs as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to manage or distribute charitable goods according to real-time and anticipated geographic or demographic needs. The memory 905 also stores the data associated with or generated by the execution of the inventive steps.

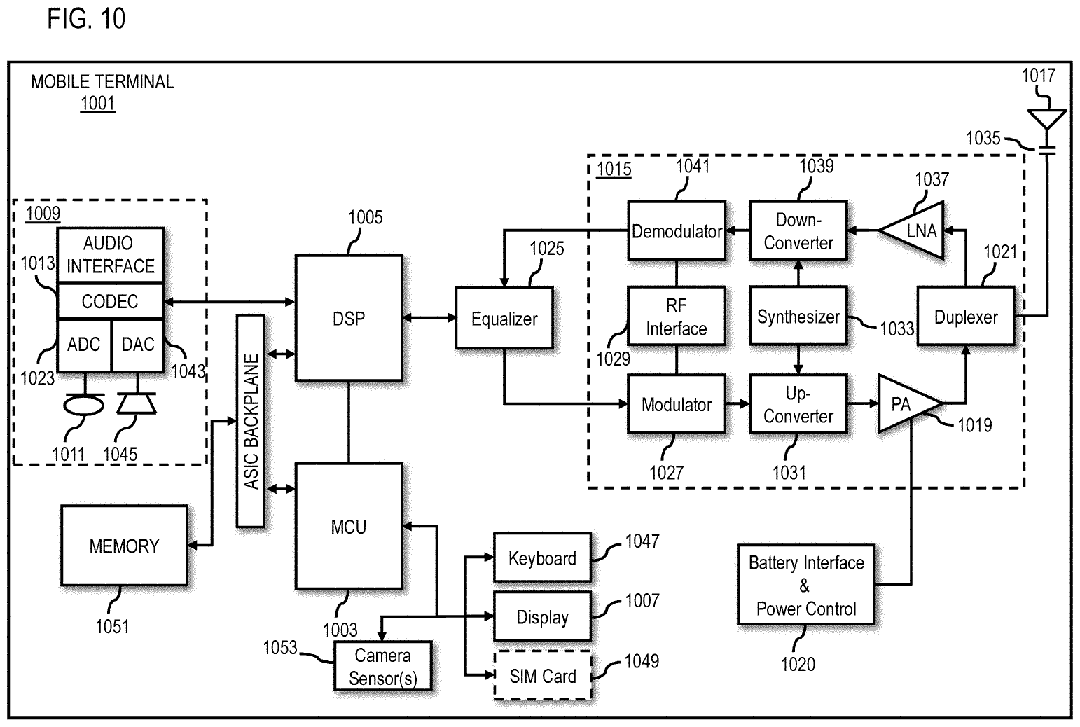

FIG. 10 is a diagram of exemplary components of a mobile terminal 1001 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), WiFi, satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to manage or distribute charitable goods according to real-time and anticipated geographic or demographic needs. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable non-transitory computer readable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for predictive management or distribution of a charitable good comprising:
determining need-based data, wherein the need-based data includes location-based data indicating at least one condition resulting in a need for the charitable good;
processing the need-based data in combination with location-based demographic data, real-time location-based contextual data, or a combination thereof to compute a predicted need for the charitable good, wherein the predicted need includes a predicted geofenced boundary and a predicted time at which the predicted need is to occur;
monitoring inventory data for the charitable good within a geographic area encompassed by the predicted geofenced boundary; and
providing an output including a recommended parameter for initiating the management or the distribution of the charitable good within the geographic area based on the predicted need and the monitored inventory data.

2. The method of claim 1, further comprising:
computing a distribution route for distributing the charitable good within the geographic area to the predicted geofenced boundary based on the monitored inventory data and the predicted time of the predicted need,
wherein the recommended parameter includes the distribution route.

3. The method of claim 1, wherein in the need-based data includes a concentration of single mothers, a concentration of babies, a homelessness level, a poverty level, a concentration of elderly people, a level of drug use, a concentration of troubled youths, or a combination thereof.

4. The method of claim 1, wherein the real-time location-based contextual data includes an emergency condition, the method further comprising:
creating a response profile for the emergency condition based on the output,
wherein the response profile can be initiated on an occurrence or a recurrence of the emergency condition.

5. The method of claim 1, further comprising:
generating a map user interface depicting a representation of the predicted need, the predicted geofenced boundary, the predicted time, or a combination thereof.

6. The method of claim 5, wherein the map user interface is updated as the predicted need, the predicted geofenced boundary, the predicted time, or a combination thereof is updated.

7. The method of claim 1, wherein the recommended parameter of the output includes a location of a charitable center within a predetermined threshold distance of a donor, the method further comprising:
transmitting the output to a device of the donor,
wherein the output further identifies the charitable good corresponding to the predicted need.

8. The method of claim 1, wherein the recommended parameter of the output includes a location of a charitable center in or within a predetermined threshold distance of the geofenced boundary from which a need recipient can obtain the charitable good, the method further comprising:
transmitting the output to a device of the need recipient.

9. The method of claim 1, further comprising:
prioritizing the management or the distribution of the charitable good among a plurality of other charitable goods based on the predicted time of the predicted need for the charitable good.

10. The method of claim 1, wherein the output includes a report of the monitored inventory against the predicted need of the charitable good.

11. An apparatus for predictive management or distribution of a charitable good comprising:
at least one processor; and
at least one memory including computer program code for one or more programs,
the at least one memory and the computer program code configured to, with the at least one processor, cause the apparatus to perform at least the following,
determine need-based data, wherein the need-based data includes location-based data indicating at least one condition resulting in a need for the charitable good;
process the need-based data in combination with location-based demographic data, real-time location-based contextual data, or a combination thereof to compute a predicted need for the charitable good, wherein the predicted need includes a predicted geofenced boundary and a predicted time at which the predicted need is to occur;
monitor inventory data for the charitable good within a geographic area encompassed by the predicted geofenced boundary; and
provide an output including a recommended parameter for initiating the management or the distribution of the charitable good within the geographic area based on the predicted need and the monitored inventory data.

12. The apparatus of claim 11, wherein the apparatus is further caused to:
compute a distribution route for distributing the charitable good within the geographic area to the predicted geofenced boundary based on the monitored inventory data and the predicted time of the predicted need,
wherein the recommended parameter includes the distribution route.

13. The apparatus of claim 11, wherein in the need-based data includes a concentration of single mothers, a homelessness level, a poverty level, a concentration of elderly people, a level of drug use, a concentration of troubled youths, or a combination thereof.

14. The apparatus of claim 11, wherein the real-time location-based contextual data includes an emergency condition, the apparatus is further caused to:
create a response profile for the emergency condition based on the output,
wherein the response profile can be initiated on an occurrence or a recurrence of the emergency condition.

15. The apparatus of claim 11, wherein the apparatus is further caused to:
generate a map user interface depicting a representation of the predicted need, the predicted geofenced boundary, the predicted time, or a combination thereof.

16. The apparatus of claim 15, wherein the map user interface is updated as the predicted need, the predicted geofenced boundary, the predicted time, or a combination thereof is updated.

17. A non-transitory computer-readable storage medium for predictive management or distribution of a good, carrying one or more sequences of one or more instructions which, when executed by one or more processors, cause an apparatus to at least perform the following steps:
determining need-based data, wherein the need-based data includes location-based data indicating at least one condition resulting in a need for the charitable good;
processing the need-based data in combination with location-based demographic data, real-time location-based contextual data, or a combination thereof to compute a predicted need for the good, wherein the predicted need includes a predicted geofenced boundary and a predicted time at which the predicted need is to occur;
monitoring inventory data for the good within a geographic area encompassed by the predicted geofenced boundary; and
providing an output including a recommended parameter for initiating the management or the distribution of the good within the geographic area based on the predicted need and the monitored inventory data.

18. The non-transitory computer-readable storage medium of claim 17, wherein the apparatus is further caused to perform:
computing a distribution route for distributing the good within the geographic area to the predicted geofenced boundary based on the monitored inventory data and the predicted time of the predicted need,
wherein the recommended parameter includes the distribution route.

19. The non-transitory computer-readable storage medium of claim 17, wherein in the need-based data includes a concentration of single mothers, a homelessness level, a poverty level, a concentration of elderly people, a level of drug use, a concentration of troubled youths, or a combination thereof.

20. The non-transitory computer-readable storage medium of claim 17, wherein the real-time location-based contextual data includes an emergency condition, the apparatus is further caused to perform:
creating a response profile for the emergency condition based on the output.
